(19) United States
(12) Patent Application Publication
(10) Pub. No.: US 2012/0194939 A1
(43) Pub. Date: Aug. 2, 2012

(54) PATTERNED MEDIUM INSPECTION METHOD AND INSPECTION APPARATUS

(76) Inventors: Takuma NISHIMOTO, Fujisawa (JP); Masami Makuuchi, Yokohama (JP); Yoshihiro Sakurai, Hadano (JP); Kunihito Higa, Isehara (JP); Fujio Onishi, Yokohama (JP)

(21) Appl. No.: 13/316,668

(22) Filed: Dec. 12, 2011

(30) Foreign Application Priority Data
Jan. 31, 2011 (JP) JP2011-017400

(51) Int. Cl. G11B 5/09

(52) U.S. Cl. 360/51; G9B/5.033

(57) ABSTRACT

A patterned medium inspection method according to the present invention includes a timing computation process including a read process reading the reproduced signal of a patterned medium under inspection and a computation process computing the signal interval values from the patterned medium reproduced signal read in the read process, and a judgment process judging the quality of the patterned medium using the reproduced signal interval values computed in the computation process.

### INCORPORATION BY REFERENCE

The present application claims priority from Japanese application JP2011-017400 filed on Jan. 31, 2011, the content of which is hereby incorporated by reference into this application.

### BACKGROUND OF THE INVENTION

The present invention pertains to a patterned medium inspection method and inspection apparatus.

Conventionally, used hard disk recording media have a structure in which a film of magnetic particles is formed on disc-shaped glass or metal and records recording units (bits) in which a fixed number of magnetic particles are lumped together. However, there is the problem that it is not possible to maintain the stored data in a stable state with an increase in the recording density, so a physical limit is encountered.

As against this, as a kind of magnetic recording medium, patterned media which are recording media in which magnetic particles (magnetic dots) have been artificially arranged with regularity can be considered to be able to increase capacity more than prior-art recording media and break through the physical limit, since, logically, recording of one bit becomes possible for one magnetic particle (magnetic dot).

As background art in the present technical field, there is JP-A-2009-295220. In this publication, there is disclosed a “phase regulation device which, together with magnetically arranging into sections a plurality of magnetic dots 31 writing or reproducing data in the down-track direction at designated spacings, arranges phase regulation track 32A in an arbitrary track inside a plurality of tracks of the surface of a BPM 3A arranging, in concentric circular shapes, a plurality of tracks that magnetically arrange into sections the plurality of magnetic tracks 31 in the cross track direction; wherein phase regulation track 32A has a phase detection bit 41 enabling the writing and reproduction of phase detection data and arranged in the down-track direction; and which, in the case of reading and writing respective ones of a plurality of phase detection bits 41 as the first detection bits, cancels phase misalignment with respect to the read/write timing by determining the first phase detection bit to be the phase detection bit for which the error rate is the lowest. (Refer to the Abstract and Paragraphs [0071] and [0079].)

### SUMMARY OF THE INVENTION

In JP-A-2009-295220, there is described a synchronization means for the read/write timing of the reads and writes to the magnetic dots of a Bit Patterned Medium (hereinafter simply mentioned as BPM), which is a kind of patterned medium.

The magnetic dots of a BPM are generated by arrangement with designated spacings by means of the self-organization phenomenon, but if there are random variations in manufacturing, the magnetic dot arrangement spacing does not become a constant. Also, in the case of providing phase controlling tracks, like the technology disclosed in JP-A-2009-295220, the arrangement of the phase regulation track magnetic dots themselves also has a random variation. However, it is assumed for the synchronization means of JP-A-2009-295220 that synchronization is accomplished with fixed timing, so if there is a random variation in the arrangement spacings, dimensions, and magnetization characteristics of individual magnetic dots, there is the issue that it is not possible to read and write (hereinafter simply mentioned as “R/W”) data with respect to the individual magnetic dots.

Accordingly, the present invention provides a patterned medium inspection method and inspection apparatus capable of accurately reading and writing data with respect to individual magnetic dots even if there are random variations in manufacturing.

In order to solve the aforementioned problem, a configuration described e.g. in the scope of patent claims is adopted. In the present application, there is included a plurality of means of solving the aforementioned problem, and if an example thereof is cited, it would be: “A patterned medium inspection method comprising: a timing computation process comprising a read process reading the reproduced signal of a patterned medium under inspection and a computation process computing the signal interval values from said patterned medium reproduced signal read in said read process; and a judgment process judging the quality of said patterned medium using said reproduced signal interval values computed in said computation process.”

These and other objects, features and advantages of the invention will become apparent from the following more particular description of preferred embodiments of the invention as illustrated in the accompanying drawings.

### BRIEF DESCRIPTION OF THE DRAWINGS

FIG. 1 is an example of a block diagram of a patterned medium inspection apparatus associated with Embodiment 1 of the present invention.

FIG. 2A is a diagram illustrating the domains of a BPM surface.

FIG. 2B is a diagram illustrating that the magnetic dots are formed into concentric circular shapes.

FIG. 2C is a diagram illustrating a cross-sectional view of a BPM.

FIG. 3 is a flow diagram of a patterned medium inspection method associated with Embodiment 1 of the present invention.

FIG. 4 is a block diagram of the magnetic dot synchronization part associated with a patterned medium inspection apparatus of Embodiment 1 of the present invention.

FIG. 5 is a flowchart of a detection gate signal and a synchronization gate signal associated with a patterned medium inspection apparatus of Embodiment 1 of the present invention.

FIG. 6 is an example of a circuit configuration representing specifically a magnetic dot synchronization part associated with a patterned medium inspection apparatus of Embodiment 1 of the present invention.

FIG. 7 is an explanatory flowchart diagram representing the operation of a magnetic dot synchronization means associated with a patterned medium inspection apparatus of Embodiment 1 of the present invention.

FIG. 8 is a diagram illustrating a method of inspecting the random variation of magnetic dot arrangement spacings.

FIG. 9 is a diagram illustrating a method of inspecting the random variation of magnetic dot sizes.

FIG. 10 is a diagram representing a variation of the magnetic dot synchronization part associated with a patterned medium inspection apparatus of Embodiment 1 of the present invention.

FIG. 11 is a diagram showing another example of detecting both the positive and negative peaks of a magnetic dot onto which a “0” or “1” data item has been written.

FIG. 12 is a diagram illustrating an example of a reproduced signal.

FIG. 13 is an example of a configuration of a magnetic disk device associated with Embodiment 2 of the present invention.

FIG. 14 is a diagram explaining the operation of a magnetic disk device associated with Embodiment 2 of the present invention.

FIG. 15 is an example of an R/W phase margin detection method.

FIG. 16 is an example of an R/W phase margin detection result.

FIG. 17 is a flowchart explaining an R/W phase margin inspection method.

### DESCRIPTION OF THE EMBODIMENTS

First, in the beginning, an explanation will be given regarding a patterned medium (BPM) being the object under inspection of a patterned medium inspection apparatus related to the present invention.

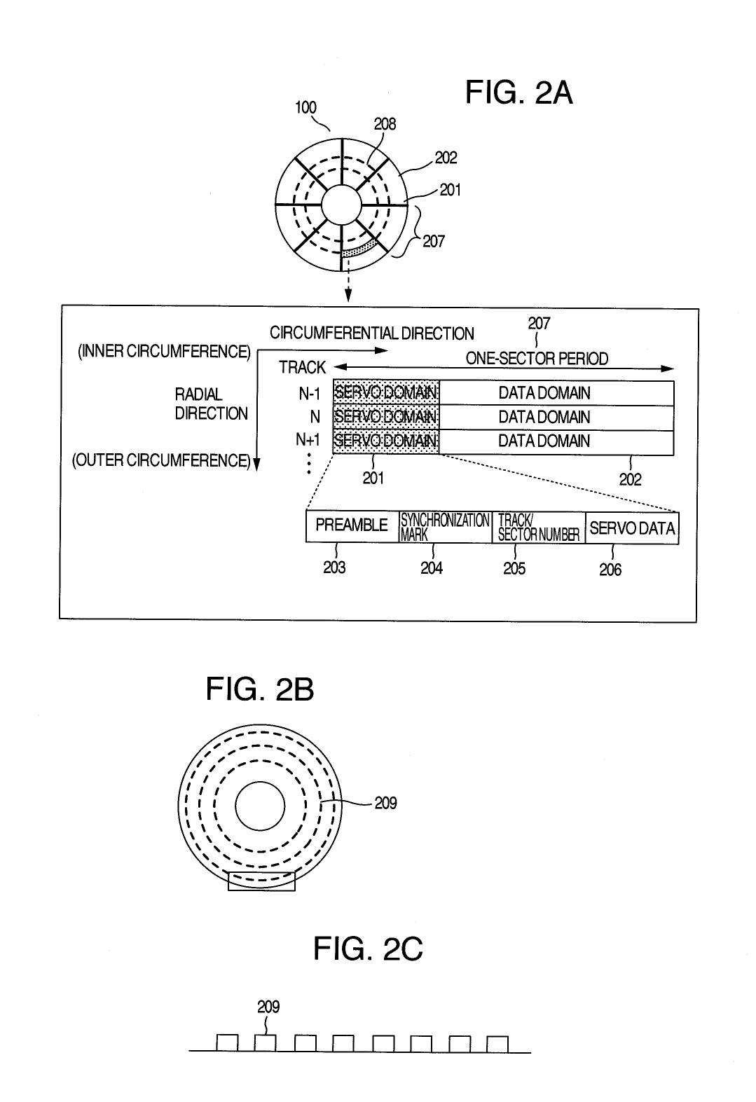

FIG. 2A is a diagram representing the domains of a BPM surface.

BPM 100 is composed of a plurality of tracks 208 that are divided into concentric circles, each track 208 being composed of a plurality of sectors 207 partitioned in the peripheral direction.

The lower part of FIG. 2A represents each of the sector 207 domain classes in concentrically arranged tracks N−1, N, and N+1. The sector 207 has, respectively, servo domains 201 and data domains 202, the servo domains 201 being configured by comprising a preamble 203, a synchronization mark 204, a track/sector number 205, and a servo data item 206.

As illustrated in FIG. 2B, magnetic dots 209 are formed concentrically in the surface of BPM 100. The magnetic dots 209 are ones where magnetic bodies are formed as dots with designated spacings by means of the self-organization phenomenon, the cross-sectional view of the portion of FIG. 2B surrounded by a rectangle being as illustrated in FIG. 2C.

Hereinafter, embodiments of a patterned medium inspection apparatus related to the present invention will be described using the drawings.

### First Embodiment

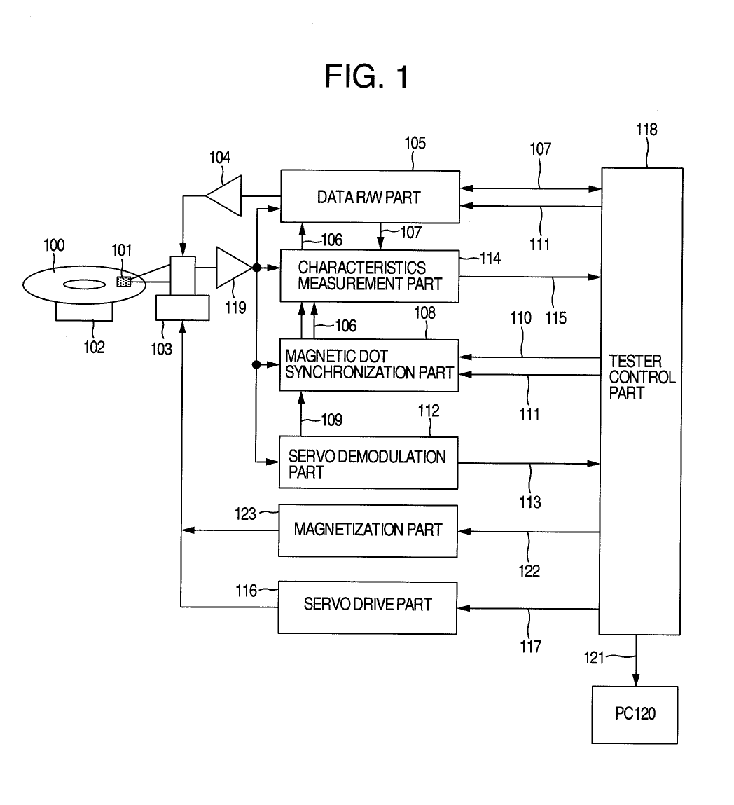

FIG. 1 is an example of a block diagram of a patterned medium inspection apparatus associated with Embodiment 1 of the present invention.

The patterned medium inspection apparatus is constituted by having a magnetic head 101, a spindle 102, a stage 103, amplifiers 104 and 119, a data R/W part 105, a magnetic dot synchronization part 108, a servo demodulation part 112, a characteristics measurement part 114, a servo drive part 116, a magnetization part 123, a tester control part 118, and a PC (Personal Computer) 120.

Magnetization part 123 receives a magnetization signal 122 from test control part 118 and magnetizes BPM 100 surface magnetic dots in one direction.

Spindle 102 holds and places BPM 100 which is the object under inspection and rotatably controls BPM 100 during inspection.

Stage 103 is equipped with magnetic head 101 and operates magnetic head 101 by means of a control signal from servo drive part 116.

Magnetic head 101 is held and placed by stage 103 and executes reads and writes with respect to BPM 100 in response to a data signal and a magnetic dot synchronization signal 106 from data R/W part 105.

Amplifier 119 amplifies reproduced signals read with magnetic head 101 and data signals such as read data and sends the same to data R/W part 105, characteristics measurement part 114, magnetic dot synchronization part 108, and servo modulation part 112.

Amplifier 104 amplifies the data signal from data R/W part 105 and sends the same to magnetic head 101.

Servo modulation part 112 detects a servo domain 201, from a reproduced signal read with magnetic head 101 and amplified with amplifier 119, and respectively outputs synchronization signal 109 from synchronization mark 204 of detected servo domain 201 and a demodulation result 113 from a track sector number 205 and a servo data item 206. Here, the term “synchronization signal” refers to a number for aiming at the start timing of the servo domain and is sent to magnetic dot synchronization part 108. Also, the term “demodulation result” 113 refers to information indicating which track sector on the BPM is reproduced by the reproduced signal as well as servo domain information and is sent to tester control part 118.

Data R/W part 105 demodulates the data content (R/W data 107) from the reproduced signal, read data, or the like, using synchronization signal 109 output from servo demodulation part 112 and outputs this to tester control part 118. Also, it writes a data signal to BPM 100 with the timing of magnetic dot synchronization signal 106 from magnetic dot synchronization part 108 and read data from BPM 100.

Tester control part 118 detects the position on BPM 100 of magnetic dot 101 from demodulation result 113 sent from servo demodulation part 112, requests the amount of movement needed to move magnetic head 101 to the track targeted for detection, and outputs a movement signal 117 to servo drive part 116.

Servo drive part 116, if receiving a movement signal 117 from tester control part 118, controls stage 103 and moves magnetic head 101 to the track under inspection.

If magnetic head 101 moves to the position under inspection by means of servo drive part 116, magnetic dot synchronization part 108, detects, on the basis of control signals such as a synchronization signal 109, a data domain interval 110, and a mode signal 111, the waveform interval values (signal interval values) of the reproduced signal and saves the same in memory. Also, it computes magnetic dot synchronization signal 106 on the basis of this and sends the same to characteristics measurement part 114 and data R/W part 105. Here, the data domain interval 110 is predetermined for each BPM, the same information being sent from tester control part 118. In addition, mode signal 111 is also sent from tester control part 118. When sending magnetic dot synchronization signal 106 from magnetic dot synchronization part 108 to characteristics measurement part 114, the signal interval values may also be sent together herewith.

Characteristics measurement part 114 measures the BPM characteristics using the signal interval values from magnetic dot synchronization part 108. Also, it measures the BPM characteristics using read result 107 from data R/W part 105. And then, it sends a characteristics measurement result 115 in which the result of the measurement has been obtained to tester control part 118.

PC 120 receives a judgment result 121 from tester control part 121 and teaches it to the user.

Next, a patterned medium inspection method related to the present invention will be described.

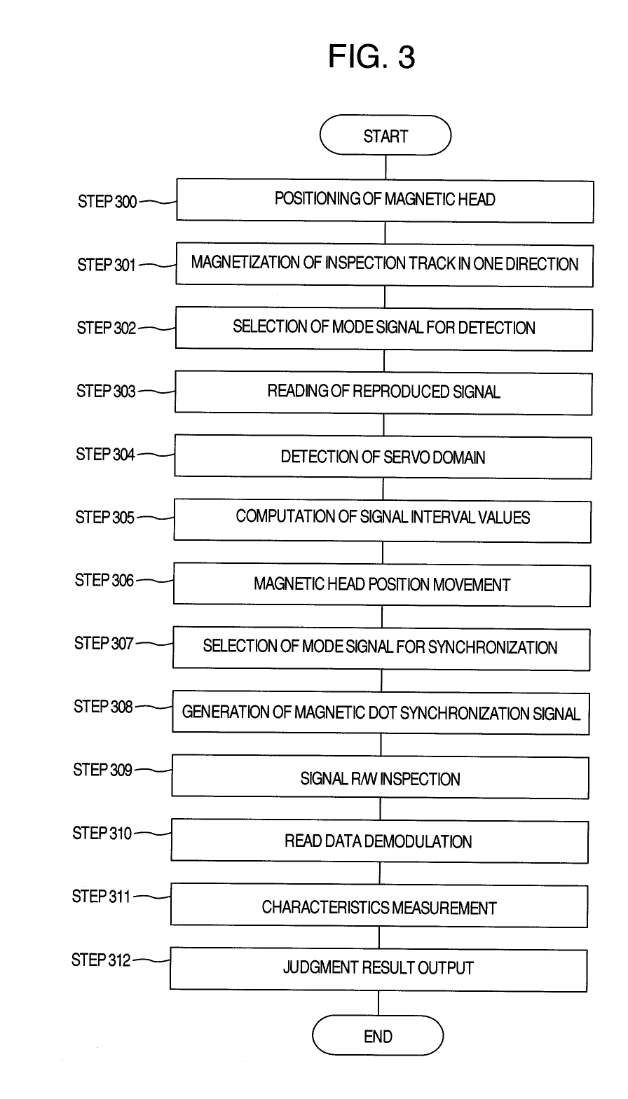

FIG. 3 is a flow diagram of a patterned medium inspection method associated with Embodiment 1 of the present invention.

In Step 300, there is carried out control of the track positioning of magnetic head 101 moving magnetic head 101 to the track under inspection on the surface of BPM 100. The start position tracks are predetermined for each BPM 100 and, on the basis of movement signal 117 transmitted from test control part 118, servo drive part 116 controls stage 103 and moves magnetic head 101 to the track under inspection.

In Step 301, the surface of the BPM 100 being the object under inspection is magnetized in one direction. Magnetization part 123 instructs magnetic head 101 to apply a magnetic field on the surface of BPM 100 on the basis of magnetization signal 122 transmitted from tester control part 118. In this way, magnetic head 101 applies a magnetic field to BPM 100 and magnetizes, in one direction, magnetic dots forming a track targeted for detection.

In Step 302, mode signal 111 is set to “detection” mode. When it comes to mode signal 111, there are the “detection mode” and the “synchronization mode”, the “detection mode” referring to a mode reading a reproduced signal from BPM 100 and computing an interval value of a signal and the “synchronization mode” referring to a mode performing R/W processing to BPM 100 with timing based on the signal interval values and detecting the read data. Here, by transmitting a “detection mode” mode signal 111 from tester control part 118 to data R/W part 105 and magnetic dot synchronization part 108, the “detection mode” is entered.

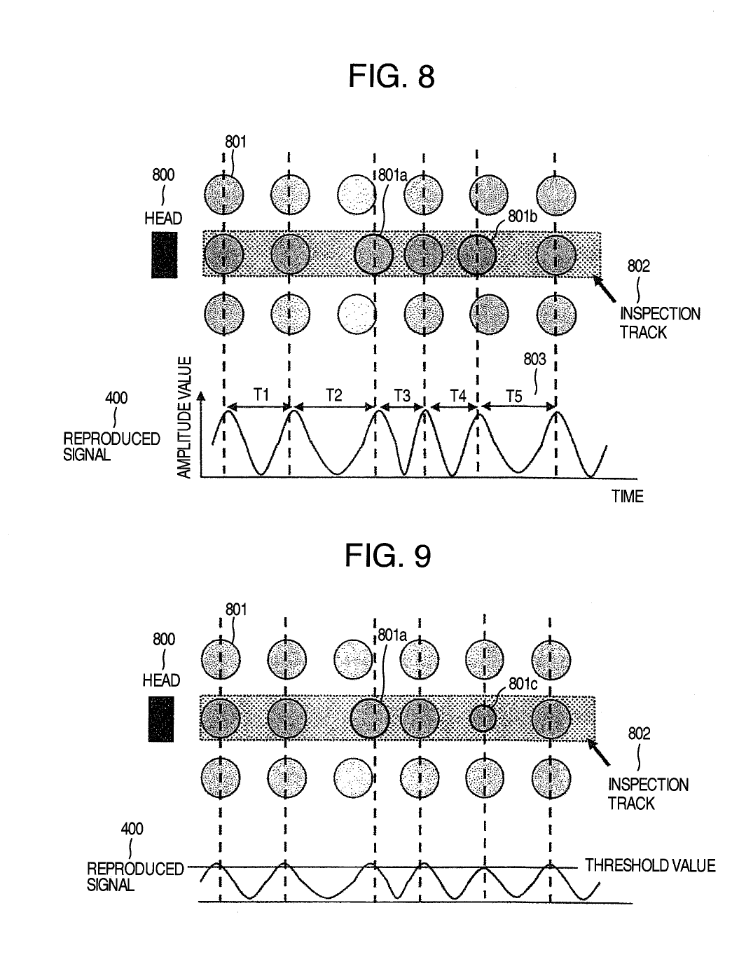

In Step 303, the reproduced signal from BPM 100 is read. Here, the term “reproduced signal” refers to a signal obtained by having magnetic head 101 read the surface of BPM 100 moving in rotation, which is a signal corresponding to the magnetic field strength value generated by the magnetic dots formed in the magnetic body. Magnetic head 101, instructed by data R/W part 105 having received a “detection mode” mode signal 111, reads the reproduced signal of the surface of BPM 100 and sends the read data to R/W part 105, characteristics measurement part 114, magnetic head sync part 108, and servo demodulation part 112. Since the surface of BPM 100 is magnetized in one direction in Step 301, the result is that there are alternately detected, in the surface of BPM 100, a signal (“1”) from the magnetic dot domain and a signal (“0”) from a domain where no magnetic dot is formed. At this point, in the case where the magnetic dot array positions do not have equal intervals, there occurs, as shown in the lower row of FIG. 8, a deviation also in the waveform period of the reproduced signal, so the period no longer has equal intervals.

In Step 304, servo demodulation part 112 detects servo domain 201 on the basis of the reproduced signal. The synchronization signal 109 from synchronization mark 204 of servo domain 201 and the demodulation results 113 from track sector number 205 and servo data 206 are respectively detected, synchronization signal 109 which is a signal for aiming at the start timing of the servo domain is sent to magnetic dot synchronization part 108 and demodulation results 113 such as servo domain information are respectively sent to test control part 118.

In Step 305, signal interval values 803 are computed in magnetic dot synchronization part 108. On the basis of synchronization signal 109 sent from servo demodulation part 112 in Step 304 and the reproduced signal read in Step 303, signal interval values 803 of the reproduced signal are computed and saved in memory. Here, signal interval values 803 mean computed values related with the period of the reproduced signal waveform, e.g. the intervals of time for the reproduced signal strength to reach a peak, the interval of the timing for the strength of the reproduced signal to exceed a designated threshold, or the like. On the occasion of reading the reproduced signal, signal interval values 803 change in response to the distance between magnetic dots of BPM 100 in order to make magnetic head 101 move with roughly the same speed. If the distance between magnetic dots is great, signal interval values 803 increase and if the distance between magnetic dots is small, signal interval values 803 decrease.

In Step 306, the position of magnetic head 101 is moved. Tester control part 118 detects, on the basis of demodulation result 113 sent from servo demodulation part 112 in Step 304, the current position of magnetic head 101 on BPM 100, finds the amount of movement needed to move magnetic head 101 up to the track targeted for detection, and outputs movement signal 117 to servo drive part 116.

In Step 307, mode signal 111 is set to the “synchronization mode”. By transmitting a “synchronization mode” mode signal 111 from tester control part 118 to data R/W part 105 and magnetic head synchronization part 108, the “synchronization mode” is entered.

In Step 308, magnetic dot synchronization signal 106 is generated. In magnetic dot synchronization part 108, magnetic dot synchronization signal 106 is computed on the basis of the waveform interval value (signal interval value) of the reproduced signal computed in Step 305, and this is sent to characteristics measurement part 114 and data R/W part 105.

In Step 309, magnetic head 101 writes a data signal to BPM 100 and reads data from BPM 100 with timing based on magnetic dot synchronization signal 106. The read data that have been read are sent to data R/W part 105, characteristics measurement part 114, magnetic dot synchronization part 108, and servo demodulation part 112. By carrying out reading and writing to magnetic head 101 with timing based on magnetic dot synchronization signal 106, since R/W processing can be performed with timing that takes into account the arrangement misalignment of the magnetic dots, it is possible to read and write data at the center of the structure even with respect to magnetic dots having positional deviation.

In Step 310, read data from BPM 100 are demodulated in data R/W part 105 and read data (R/W data) 107 are sent to tester control part 118 and characteristics measurement part 114.

In Step 311, the characteristics of BPM 100 are measured using magnetic dot synchronization signal 106 and the read data 107 demodulated in Step 310.

As mentioned above, since magnetic dot synchronization signal 106 is one that is computed on the basis of the signal interval values of the reproduced signal and the signal interval values of the reproduced signal are values that depend on the distance between magnetic dots, it is possible, by evaluating magnetic dot synchronization signal 106, to judge whether or not there is any deviation in the arrangement of the magnetic dots. In the case where the arrangement of magnetic dots has a deviation that is equal to or exceeds a designated value, since there results a faulty BPM for which defects are generated when the user performs R/W processing with a drive, by judging whether or not the signal interval values of the reproduced signal of BPM 100 under inspection are within a predetermined threshold value (threshold value of the signal interval) for the positional misalignment of the magnetic dots, it is possible to carry out a judgment (good/bad judgment) of whether BPM 100 satisfies the quality requested by the user. Further, it is possible to judge the positional misalignment of the magnetic dots not only with magnetic dot synchronization signal 106 but also with signal interval values 803.

Also, since the strength of the reproduced signal (amplitude value of reproduced signal waveform) depends on the magnetic dots which are the magnetic body, it is possible, by evaluating the strength of the reproduced signal, to judge whether there is any deviation or not in the size of the magnetic dots. In other words, since the size of the reproduced signal is based on the size of the magnetic field base on the magnetic dots, in the case where the radius of a magnetic dot is small compared to that of the other magnetic dots even if there is no deviation in the position of the magnetic dot, like magnetic dot 801c of FIG. 9, the obtained reproduced signal strength becomes small. Consequently, in the case where the size of a magnetic dot has a deviation which is equal to or greater than a designated value, since the possibility is high that a fault is generated when the user processes reading and writing with the drive, it is possible to carry out a judgment (good/bad judgment) of whether or not BPM 100 satisfies the quality requested by the user by judging whether the reproduced signal strength of the BPM 100 under inspection is within the predetermined threshold value (signal strength threshold value) of the deviation in magnetic dot size.

In addition, by comparing the read data demodulated in Step 310 with the data signal written with data R/W part 105, it is possible to judge whether or not the magnetic dots of BPM 100 are capable of being properly read and written.

In Step 312, there is output the judgment result of the characteristics of BPM 100 measured in Step 311. The characteristics are measured in characteristics measurement part 114 and judgment result 115 is transmitted to tester control part 118. The transmitted judgment result 121 is sent to PC 120, so the user can make a check on the GUI (Graphic User Interface).

Here, Step 300 and Step 301 must not necessarily have this order, the inverse also being acceptable.

Also, the movement of the position of magnetic head 101 of Step 306 may be executed after making a setting to “detection mode”.

According to Embodiment 1 of the present invention, it is possible, by requesting a signal interval value, to carry out a test of the medium as to whether the same random variations are within the quality tolerance of the medium, in case there are random variations in the individual arrangement spacings, dimensions and magnetic characteristics of magnetic dots formed in the surface of the BPM due to random variations in manufacturing. Also, in response to the random variations in the magnetic dots, it is possible, by adjusting the timing of the R/W inspections, to carry out a test of the medium as to whether the R/W processing of the medium can be conducted appropriately. In addition, it is possible to carry out a magnetic head test as to whether the magnetic head carrying out the R/W processing can appropriately perform reading and writing in the case of carrying out the same test using a medium recognized to be appropriate in advance.

Next, a description will be given in detail regarding magnetic dot synchronization part 108 computing the signal interval value.

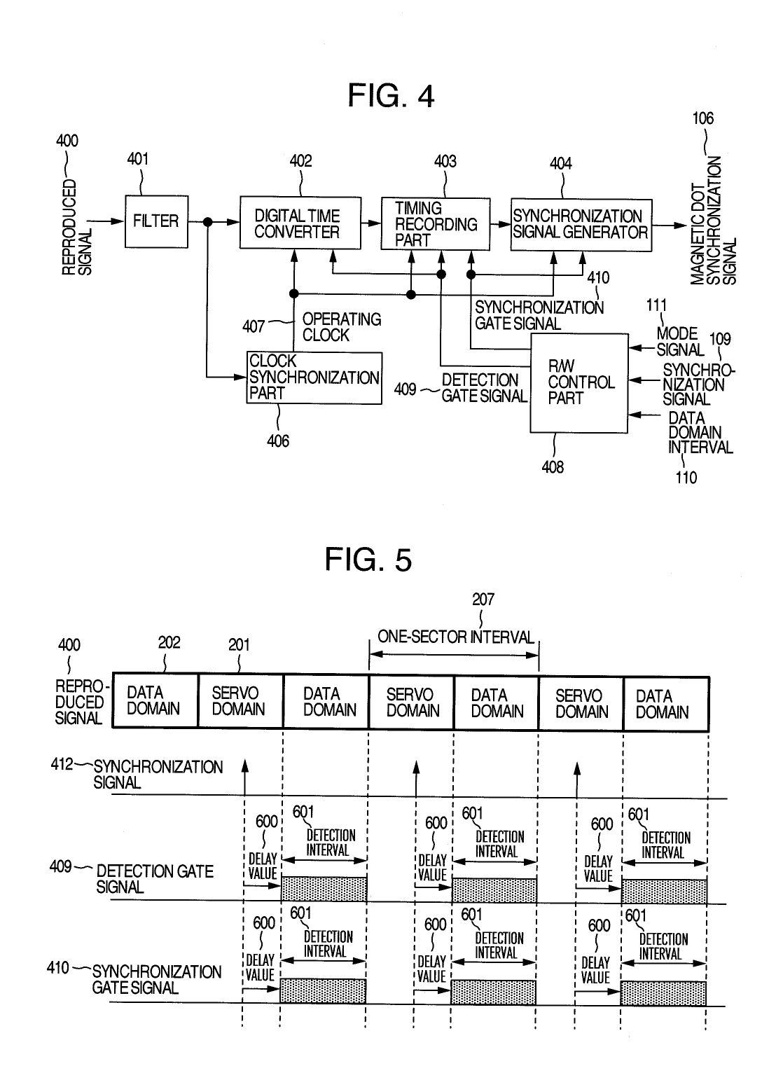

FIG. 4 is a block diagram of magnetic dot synchronization part 108 associated with the patterned medium inspection apparatus of Embodiment 1 of the present invention.

The magnetic dot synchronization part has a filter 401, a digital time converter 402, a timing recording part 403, a synchronization signal generator 404, a clock synchronization part 406, and an R/W control part 408.

Hereinafter, a description will be given regarding the operation of magnetic dot synchronization part 108.

If a “detection mode” mode signal 111 is input with respect to R/W control part 408 from tester control part 118, R/W control part 408 outputs a detection gate signal 409 to digital time converter 402 on the basis of the already known synchronization signal 109 and data domain interval 110. Also, if a “synchronization mode” mode signal 111 is input with respect to R/W control part 408 from tester control part 118, R/W control part 408 outputs a synchronization gate signal 410 to digital time converter 402 on the basis of synchronization signal 109 and data domain interval 110.

If detection gate signal 409 is output to digital time converter 402, the noise of reproduced signal 400 that has been read by magnetic head 101 is eliminated with filter 401, signal interval values 803 of reproduced signal 400 equalized to a signal waveform that is appropriate for detection by digital time converter 402 is detected, detected signal interval values 803 are output to timing recording part 403, and signal interval values 803 are saved in the internal memory of timing recording part 403.

If synchronization gate signal 410 is output to digital time converter 402, timing recording part 403 outputs signal interval values 803 saved in memory to synchronization signal generator 404 and synchronization signal generator 404 outputs the pulse signal of signal interval values 803 input from timing recording part 403 to characteristics measurement part 114 and data R/W part 105 as a magnetic dot synchronization signal 106.

Clock synchronization part 406 outputs an operating clock 407 of digital time converter 402, timing recording part 403 and synchronization signal generator 404. This clock synchronization part 406 synchronizes preamble 203 and operating clock 407 from reproduced signal 400. In this way, it is possible to compensate the variations in R/W timing due to the rotation fluctuations of spindle 102 that rotates BPM 100.

FIG. 5 is a flowchart of a detection gate signal and a synchronization gate signal associated with the patterned medium inspection apparatus of Embodiment 1 of the present invention.

R/W control part 408 makes a delay of just the interval of delay value 600 from synchronization signal 412 being the detection signal of the synchronization mark included in servo domain 201 and generates an enabling signal for just the time of detection interval 601. Delay value 600 and detection interval 601 are supplied with data domain interval 110 input from the tester control part. Here, since synchronization gate signal 410 is output on the basis of the signal interval values computed by means of detection gate signal 409, it is possible to output a signal maintaining roughly the same delay value 600 and detection interval 601 with respect to synchronization signal 412 in each sector.

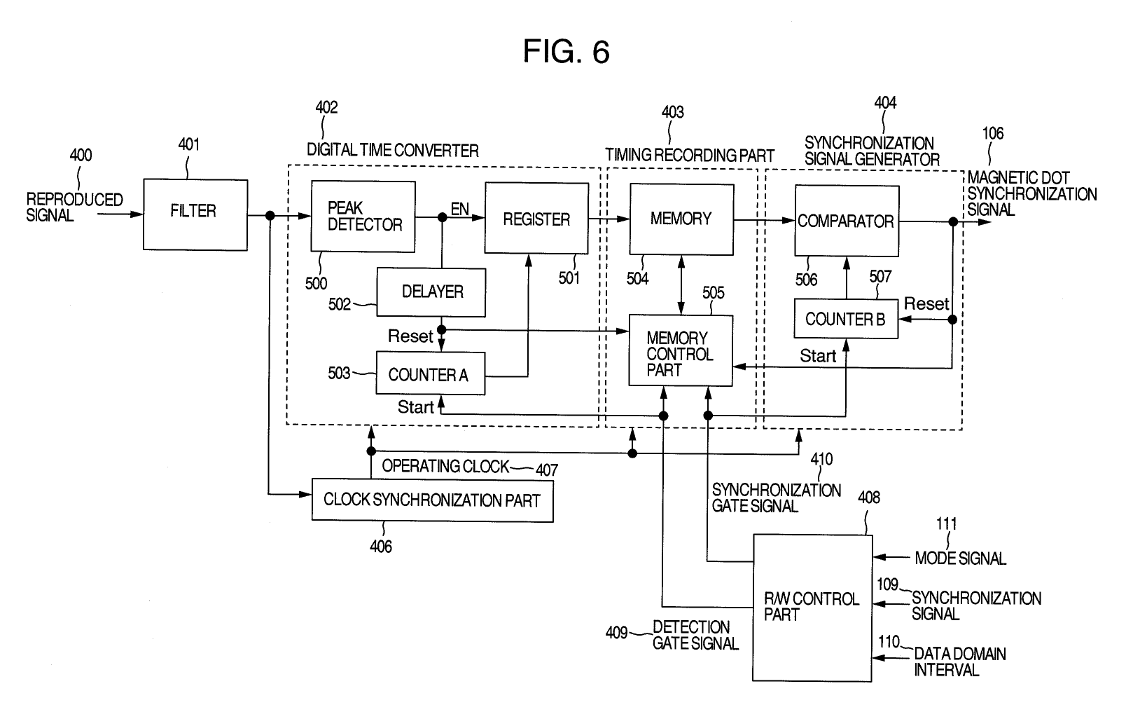

FIG. 6 is an example of a circuit configuration showing specifically a magnetic dot synchronization part associated with the patterned medium inspection apparatus of Embodiment 1 of the present invention, describing FIG. 4 in greater detail.

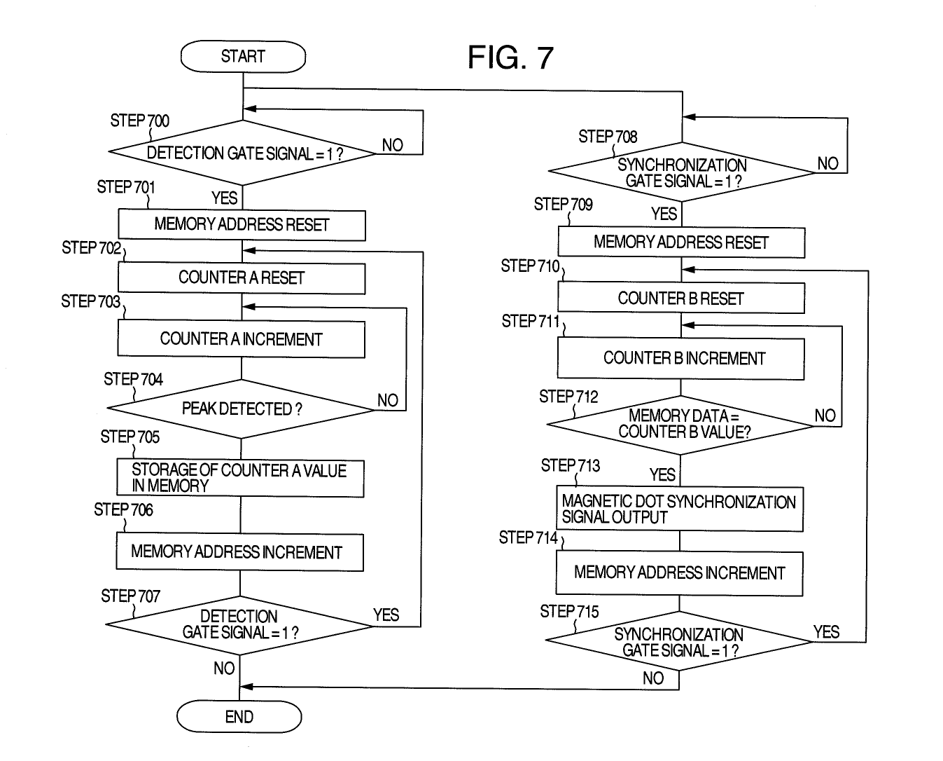

Digital time converter 402 has a peak detector 500, a register 501, a delayer 502 and a counter A 503, timing recording part 403 has a memory 504 and a memory control part 505, and synchronization signal generator 404 has a comparator 506 and a counter B 507. Regarding the operation of the magnetic dot synchronization part of FIG. 6, a description will be given using FIG. 7.

FIG. 7 is a flowchart explanatory diagram explaining the operation of magnetic dot synchronization means associated with a patterned medium inspection apparatus of Embodiment 1 of the present invention.

If detection gate signal 409 is enabled from R/W control part 408, the memory addresses of counter A 503 and memory 504 are reset. Counter A 503 gets incremented with the timing of operating clock 407 from clock synchronization part 406 and peak detector 500 detects the peak of reproduced signal 400 and outputs the detection signal to register 501 and delayer 502. Register 501 saves the value of counter A 503 if a detection signal is input. Delayer 502 delays the detection signal by just one clock period of operating clock 407 and outputs the same to counter A 503 and memory control part 505.

If a detection signal delayed by one clock period is input, memory control part 505 saves the value of counter A 503 saved in register 501 in memory 504 and increments the memory address. Counter A 503 resets the counter value to “0” with a timing that the detection signal has been delayed by one clock period, and once again starts incrementing. During the interval in which detection gate signal 409 is enabled, the aforementioned operation is repeated.

On the other hand, if synchronization gate signal 410 is enabled from R/W control part 408, the memory addresses of counter B 507 and memory 504 are reset. Memory 504 outputs the memory address data to comparator 506. Counter B 507 gets incremented with the timing of operating clock 407 and outputs the count value to comparator 506. Comparator 506 compares the memory output value and the output value of counter B, and outputs, with the timing when the values have become equal, one pulse signal as magnetic dot synchronization signal 106 to characteristics measurement part 114 and data R/W part 105. Also, the output of comparator 506 is also input to counter B 507 and memory control part 505 and, with the output timing of comparator 506, counter B 507 resets the counter value to “0” and once again starts incrementing, and memory control part 505 increments the memory address. During the interval that synchronization gate signal 410 is enabled; the aforementioned operation is repeated.

So far, a method of acquiring a reproduced signal after applying a magnetic field to the surface of BPM 100 under inspection and magnetizing the same in one direction, and computing signal interval values 803 (magnetization part 123 of FIG. 1 and Step 301 of FIG. 3) has been described, but it is also possible to acquire a reproduced signal without magnetizing in one direction. Hereinafter, there will be described a method of acquiring a reproduced signal in a mode in which two types of data, “0” and “1”, have been written to the magnetic dots of the surface of BPM 100.

FIG. 12 is a diagram showing an example of a reproduced signal by a magnetic head.

FIG. 12 is an example of a magnetic head reproduced signal in the case where “0” or “1” data have been written to magnetic dots 801 of the BPM which is under inspection. Orientation 1100 of the magnetization of magnetic dots 801 is taken to be a “1” data item in the upward state and a “0 data item in the downward state. The signal at the time when magnetic dot 801 on which a “0” or “1” data item has been written is reproduced with magnetic head 101, showing respectively a positive amplitude when a “1” data item has been reproduced and a negative amplitude when a “0” data item has been reproduced. Because of this, in the case of acquiring reproduced signal 400 of a magnetic dot on which a “0” or “1” data item has been written, if e.g. a peak detector 500, shown in FIG. 6, detecting a positive peak value is used, it ends up overlooking a magnetic dot on which a “0” data item has been written. In other words, in order to detect signal interval values 803, even in a case like this, there is a need to detect both positive and negative peaks.

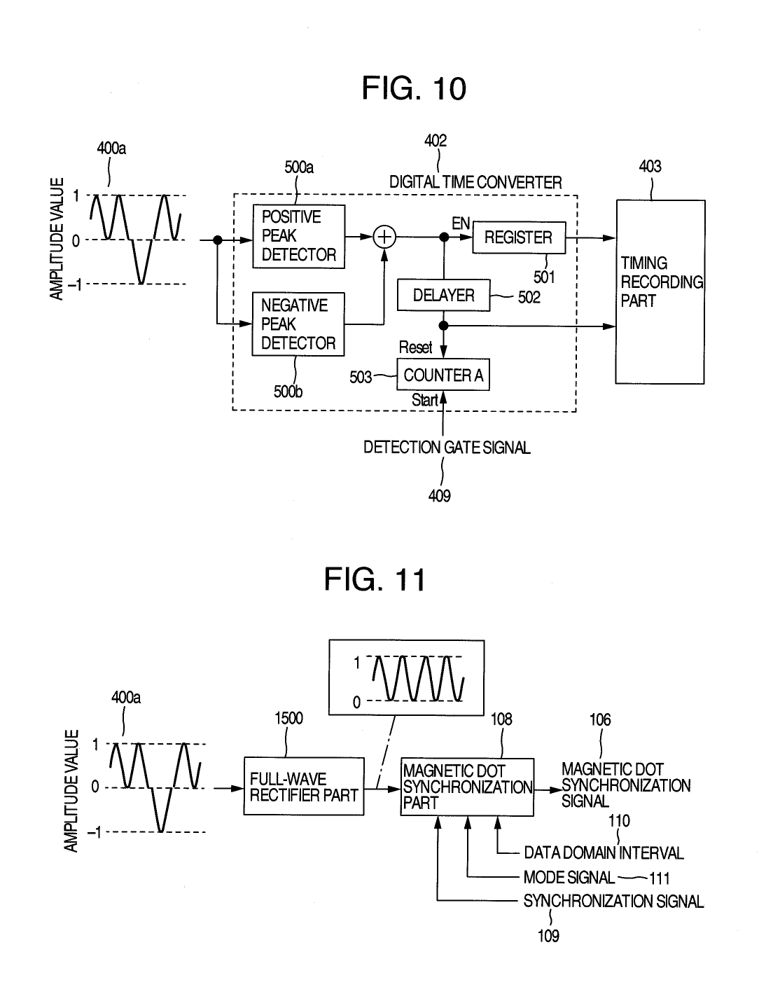

FIG. 10 is a diagram showing a variation of a magnetic dot synchronization part associated with the patterned medium inspection apparatus of Embodiment 1 of the present invention.

According to the magnetic dot synchronization part disclosed in FIG. 10, it is possible to detect, from the positive peaks and negative peaks of the reproduced signal, both the positive and negative peaks in the case of a magnetic dot on which a “0” or “1” data item has been written.

Positive peaks and negative peaks are respectively detected with a positive peak detector 500a and a negative peak detector 500b, and the count of counter A 503 is saved in register 501 with the timing enabled by a signal in which the outputs of positive peak detector 500a and negative peak detector 500b have been added and output to timing recording part 403. In this way, no matter whether either a positive or a negative peak is input, it is possible to obtain a signal interval value.

FIG. 11 is a diagram showing another example of detecting both the positive and negative peaks of a magnetic dot onto which a “0” or “1” data item has been written. As for FIG. 11, there is provided a full-wave rectifier 1500 in the pre-stage of magnetic dot synchronization part 108, so it is possible to detect signal interval values 803 without omission, even regarding magnetic dots on which a “0” data item has been written, by rectifying a reproduced signal having both positive and negative peaks via full-wave rectifier 1500 into a reproduced signal having only positive peaks.

From the above, it is possible to detect peak values of magnetic dots even when it is a state in which a “0” or “1” data item is written to a magnetic dot and to detect the centers of the magnetic dot structure.

Next, a method of inspecting random variations in magnetic dot arrangement spacings will be described using FIG. 8.

FIG. 8 is a diagram illustrating the relationship between magnetic dot array positions and a reproduced signal.

The top part of FIG. 8 illustrates a situation in which magnetic dots 801 of three tracks are concentrically arranged in the surface of BPM 100. The magnetic dots 801 in tracks of the topmost and bottommost rows are arranged with roughly the same spacings, but as for the magnetic dots 801 in the track of the center row, magnetic dot 801 a which is third from the left is arranged with a rightward deviation from the supposed original position and magnetic dot 801b which is second from the right is arranged with a leftward deviation. The bottom part of FIG. 8 illustrates the waveform of a reproduced signal 400 occurring in this center track. At this point, reproduced signal 400 has a wavelength that changes in response to the arrangement positions of magnetic dots 801, the period becoming longer for magnetic dot 801a that is arranged to the right, since the peak value of the reproduced signal is delayed and the period becoming shorter for magnetic dot 801b that is arranged to the left, since the peak value of the reproduced signal is advanced. As for signal interval values 803 (T1 to T5), since they are the intervals between the times to reach the peak values of the reproduced signal, each of the signal interval values T1 to T5 fluctuates under the influence of magnetic dots 801a and 801b having deviations.

In other words, by detecting abnormally high and low values from signal interval values 803 detected with magnetic dot synchronization part 108 and saved in memory, it is possible to detect magnetic dots 801a and 801b for which the arrangement spacings have a deviation. As a indicator identifying abnormal values, there may be used the tolerance value of the random variation in magnetic dot arrangement spacings obtained on the basis of the manufacturing specification of the BPM or a value obtained from the BER (Bit Error Rate) of the signal, or a value corresponding to the quality requested by the user to the medium may be designated separately.

Next, there will be explained a method of inspecting random variations in magnetic dot size using FIG. 9.

FIG. 9 is a diagram illustrating the relationship between magnetic dot size and the reproduced signal.

The top part of FIG. 9 illustrates, similarly to FIG. 8, the situation in which magnetic dots 801 of three tracks are concentrically arranged in the surface of BPM 100. Magnetic dots 801 in the topmost and bottommost tracks are each of roughly the same size, but magnetic dot 801c, the second on the right among the magnetic dots 801 in the center track, has a radius that is smaller than that of the other magnetic dots 801. The bottom part of FIG. 9 illustrates the waveform of reproduced signal 400 in this center track. As for the reproduced signal at this point, the amplitude value changes in response to magnetic dots 801, so the strength of the reproduced signal (peak value) corresponding to magnetic dot 801c having a small radius has become small.

In other words, by comparing the size of the peak value of reproduced signal 400 and detecting abnormally high values or low values, it is possible to detect magnetic dots whose radius sizes differ. As a indicator identifying abnormal values, the tolerance value of the random variation in magnetic dot size requested on the basis of the manufacturing specifications of the BPM or a value obtained from the BER (Bit Error Rate) of the signal may be used, or a value corresponding to the quality requested by the user to the medium may be designated.

In addition, it is also possible to test the random variation in magnetic dots due to random variation in manufacturing from the result of statistical processing of signal interval values 803 stored in memory, the distribution and standard deviation of the peak values of reproduced signal 400, or the like. The data scope handled with the present statistical processing can be determined arbitrarily, by sector, by track, for the entire BPM surface, or the like.

Next, there will be given a description regarding the R/W phase margin which is the width of the timing scope within which it is possible to read and write a signal normally.

FIG. 17 is a flowchart explaining an R/W phase margin inspection method.

First, magnetic dot synchronization part 108 is operated in the detection mode, waveform interval value 803 is acquired from the peak detection of the reproduced signal of the magnetic dots (Step 1600), after which magnetic dot synchronization part 108 is operated in the synchronization mode and magnetic dot synchronization signal 106 is output to data R/W part 105 and characteristics measurement part 114 (Step 1601). Next, the initial value P0 of the write phase is set in delay value 600 (Step 1602). The initial value P0 of the write phase is determined from the formula below.

P0=Delay Value−Tₘₐₓ/2 (1)

Here, Tₘₐₓ is the maximum value of the detected waveform interval value. Data are written to the magnetic dots with the timing of magnetic dot synchronization signal 106 generated with this set initial value P0 of the write phase (Step 1603) and, using characteristics measurement part 114, the amplitude value of the reproduced signal is acquired with the timing of magnetic dot synchronization signal 106 and saved (Step 1604). And then, the value of the write phase, shifted by just a shift amount S, is set in delay value 600 (Step 1605). The shift amount S of the write phase is indicated in the formula below.

S=Tₘₐₓ/N (2)

Here, N is the resolution of the write phase. The write phase is progressively shifted by a shift amount S at a time and data writing to the magnetic dots and acquisition of the amplitude value of the reproduced signal is performed repetitively until the value of the write phase becomes the end shift amount S_{end} (Step 1606). The end shift amount S_{end} is indicated in the formula below.

S_{end}=Delay Value+Tₘₐₓ/2 (3)

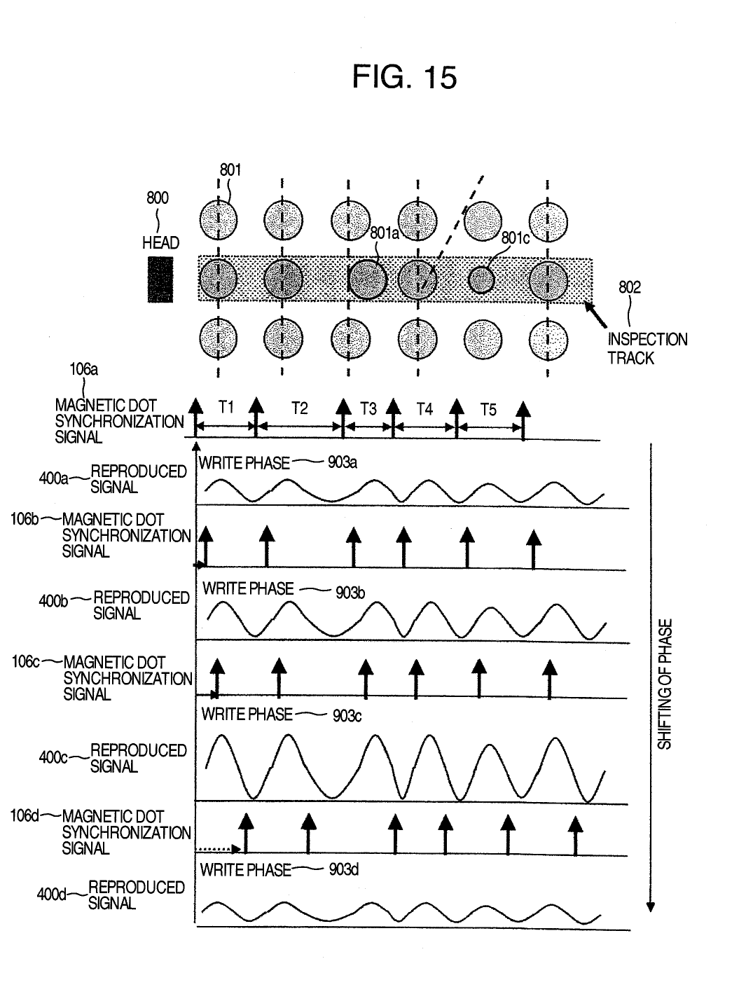

FIG. 15 is an example of an R/W phase margin detection method.

While shifting write phase 903, data writing and reproduced signal detection are repeated. For example, in the case of write phase 903c, the amplitude value of the reproduced signal indicates the maximum value of all the magnetic dots, since it is possible to write data in the center for all magnetic dots. Since the write timing gradually deviates from the center of the magnetic dots if write phase 903 progressively slips, the amplitude of the reproduced signal becomes smaller. In write phases 903a and 903d, data cannot be written on the magnetic dots and the amplitude of the reproduced signal becomes a minimum.

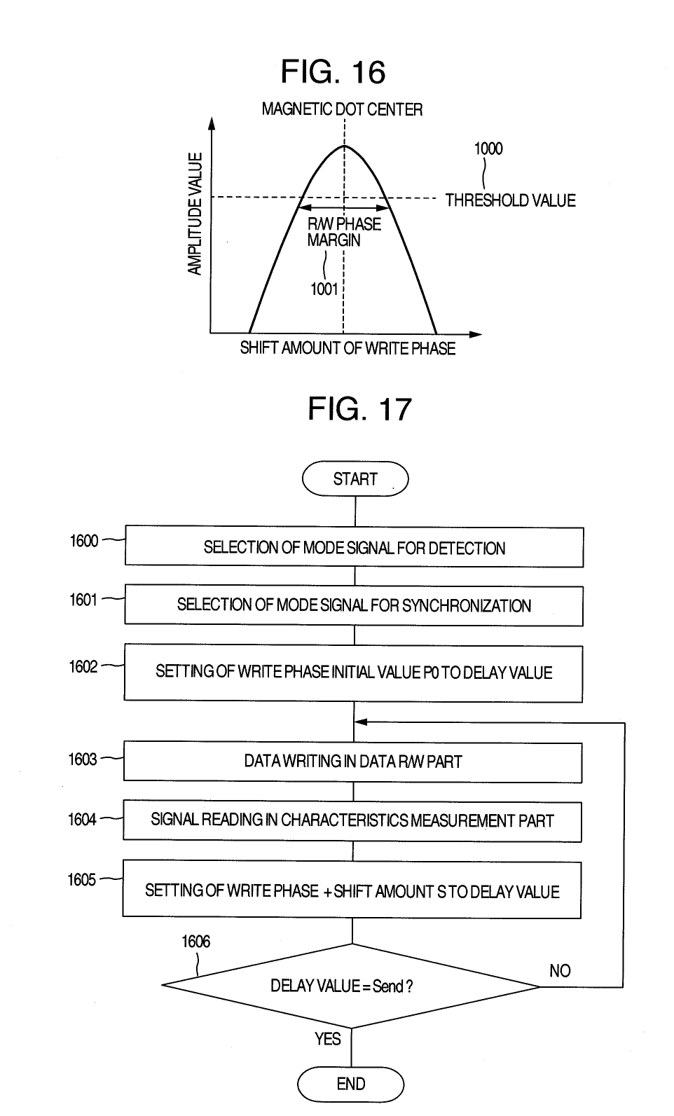

FIG. 16 is an example of an R/W phase margin detection result.

The present inspection result is that, with the abscissa representing the shift amount S of the write phase and the ordinate representing the amplitude value, there are obtained the characteristics that the amplitude value becomes a maximum for the shift amount S at the center of the magnetic dot the amplitude value declines as the write phase moves away from the center of the magnetic dot. Here, there is provided an amplitude threshold value 1000 that is necessary for demodulating the data, and the range of write phases for which an amplitude equal to or greater than threshold value 1000 can be obtained is taken to be a R/W phase margin 1001. This threshold value 1000 may be a value obtained from the signal BER (Bit Error Rate) or may be a separately designated value. From the width of this R/W phase margin 1001, it is possible to test the data R/W error rate.

From the aforementioned inspection, good-quality/defective BPM inspection and ranking become possible from the width of the R/W phase margin.

In this way, it becomes possible to detect a BPM which has great random variations in magnetic dot arrangement spacings or magnetic dot radii due to the manufacturing process and for which signals cannot be normally read and written, and to make a judgment (good/defective judgment) as to whether the BPM satisfies the quality requested by the user.

Also, in the technique disclosed in JP-A-2009-295220, there is newly provided a track for phase adjustment having magnetic dots arranged for accomplishing synchronization, so there is the problem that the data volume that the user can read and write is reduced by just the size of this track domain for phase adjustment, but according to the present invention, it is possible to carry out reading and writing corresponding to the random variation in the position of the magnetic dots, without reducing the data volume that the user can read and write.

Further, in JP-A-2009-295220, there is disclosed a drive reading and writing the BPM, but e.g., an inspection device performing a judgment as to whether the manufactured BPM satisfies the quality requested by the user or not (good item/defective item) or a quality ranking is not disclosed. For the dissemination of BPM, a BPM inspection device is mandatory, and even for magnetic dots of a BPM found to have great random manufacturing variations with the BPM inspection device, there is a need to carry out data reading and writing. However, according to the phase adjustment method disclosed in JP-A-2009-295220, data R/W with respect to magnetic dots of a BPM having great random manufacturing variation is not possible. As against this, according to the present invention, it is possible, by means of an inspection device performing a judgment (bad/defective judgment) as to whether the BPM satisfies the quality requested by the user and a quality ranking, to distinguish a BPM that does not satisfy the quality requested by the user and to sell only the BPM that satisfies a designated quality.

### Second Embodiment

In the present embodiment, there will be described an example of a magnetic disk device that is equipped with a magnetic dot synchronization part 108 that is similar to that of Embodiment 1.

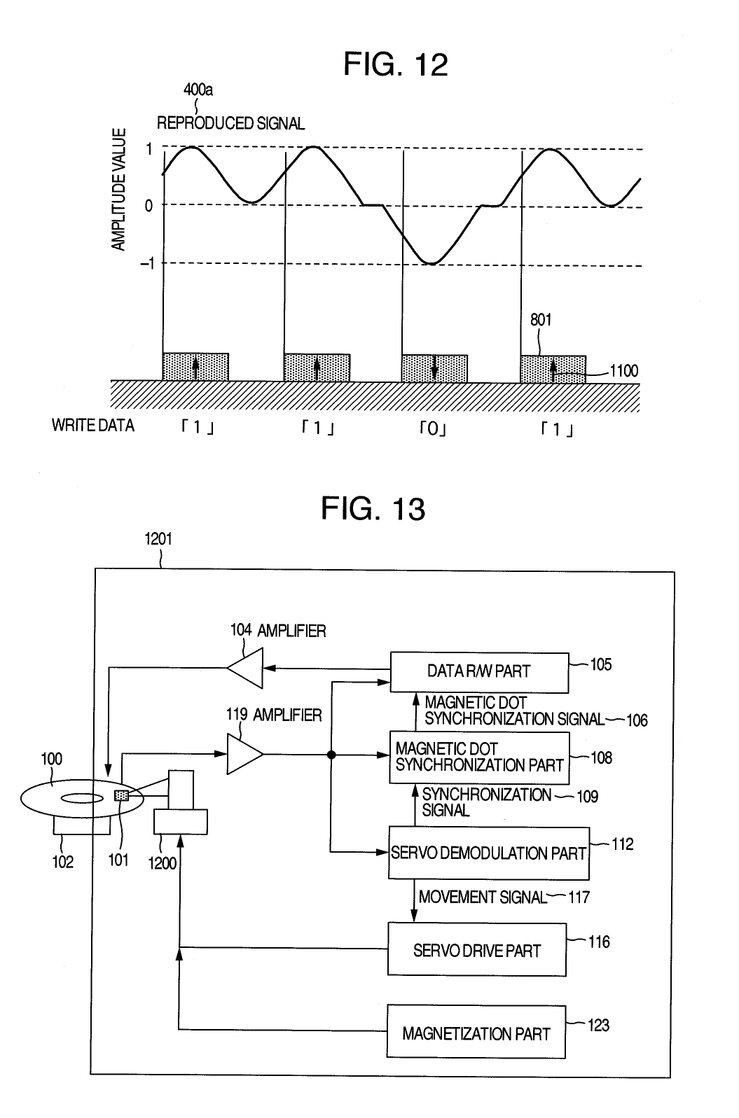

FIG. 13 is an example of a configuration of a magnetic disk device associated with Embodiment 2 of the present invention.

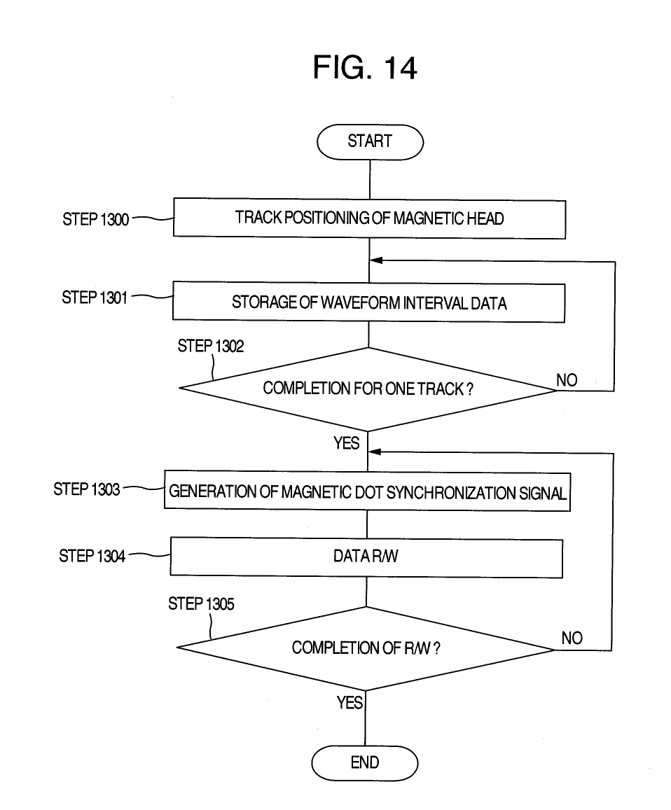

Magnetic disk device 1201 has a magnetic head 101, a spindle 102, a voice coil motor 1200, amplifiers 104 and 119, a data R/W part 105, a magnetic dot synchronization part 108, a servo demodulation part 112, a servo drive part 116, and a magnetization part 123. Regarding the operation of magnetic disk device 1201, a description will be given using FIG. 14.

FIG. 14 is a flowchart explaining the R/W operation in a magnetic disk device of Embodiment 2 of the present invention.

In Step 1300, magnetic head 101 is controlled to be positioned in the track that is the object of data reading and writing. The details of the control of the positioning are omitted since they are the same as in Step 300 of FIG. 3.

In Step 1301, magnetic dot synchronization part 108 is operated in “detection mode” and the signal interval values are detected for one track and saved in memory. As for the signal interval value detection method, it is the same as that of Steps 302 to 305 of FIG. 3.

When the storage of the signal interval values has come to an end for one track (Step 1302), there is generated in Step 1303 a magnetic dot synchronization signal and in case it has not come to an end, there is a return to Step 1301 and there is carried out computation and storage of the waveform interval values.

In Step 1304, magnetic dot synchronization part 108 is operated in “synchronization mode” and magnetic dot synchronization signal 106 is output to data R/W part 105. At this point, the data R/W part performs data reading and writing with the timing of magnetic dot synchronization signal 106.

By performing data reading and writing with the timing of magnetic dot synchronization signal 106, it is possible, even in the case where there are deviations in the arrangement positions and the size of the magnetic dots on the BPM, to carry out data reading and writing taking into account the deviations of the magnetic dots.

Here, the resolution is taken to be 8 bits, the diameter of the medium is taken to be 70 mm, the period of the magnetic dots is taken to be 20 nm, and if the necessary capacity of the memory storing the signal interval values is estimated roughly to be on the order of 12 MB (megabytes) from the formula below, the result is that there is sufficient loadable capacity in the magnetic disk device.

Memory Capacity=Resolution×(Medium Diameter×π)/(Magnetic Dot Period) (4)

In addition, in the aforementioned description, the present embodiment was explained using a method of saving in memory the signal interval values for one track, but it is acceptable to save the signal interval values for a plurality of tracks or a plurality of sectors.

From the above, since data reading and writing to and from the BPM, for which the write timing differs individually for magnetic dots due to random variations in the arrangement spacing, dimensions and magnetic characteristics of the magnetic dots, can be implemented, it becomes possible, even when it is a BPM having random variations in the magnetic dots, to equip a magnetic disk therewith.

According to the present invention, it is possible to provide a patterned medium inspection method and inspection apparatus capable of reading and writing data without regard to random variations in the arrangement spacing of magnetic dots.

Further, the present invention is not limited to the aforementioned embodiments, diverse variations being included therein. For example, the aforementioned embodiments are ones described in detail in order to describe the invention comprehensibly, but the invention is not necessarily limited to one comprising the entire described configuration. Also, it is possible to replace a part of the configuration of some embodiment with the configuration of another embodiment and, in addition, it is also possible to add another embodiment to the configuration of some embodiment. Moreover, regarding a part of the configuration of each embodiment, it is possible to make additions, deletions, and substitutions of the configuration of other embodiments.

Also, as for each of the aforementioned configurations, functions, and the like, it is acceptable to make an implementation with software by having a processor interpret a program implementing the respective functions and executing the same. It is possible to place information such as programs, tables, and files, implementing each of the functions in a recording device such as a memory, hard disk, or SSD (Solid State Drive) or a recording medium such as an IC (Integrated Circuit) card, an SD (Secure Digital) card, or a DVD (Digital Versatile Disc).

The invention may be embodied in other specific forms without departing from the spirit or essential characteristics thereof. The present embodiment is therefore to be considered in all respects as illustrative and not restrictive, the scope of the invention being indicated by the appended claims rather than by foregoing description and all changes which come within the meaning and range of equivalency of the claims are therefore intended to be embraced therein.

1. A patterned medium inspection method comprising:
a read process reading a reproduced signal of a patterned medium under inspection;
a computation process computing signal interval values from the reproduced signal of said patterned medium, read in said read process; and
a judgment process judging a quality of said patterned medium using said signal interval values computed in said computation process.

2. The patterned medium inspection method according to claim 1, wherein, in said judgment process, the quality of said patterned medium is judged by comparing said signal interval values computed in said computation process and a predetermined signal interval threshold value.

3. The patterned medium inspection method according to claim 1, wherein, in said judgment process, the quality of said patterned medium is judged by comparing a strength of said reproduced signal read in said read process and a predetermined signal strength threshold value.

4. The patterned medium inspection method according to claim 1, wherein:
said judgment process comprises an inspection process carrying out read/write processing from and to said patterned medium with timing based on said signal interval values computed in said computation process; and,
in said judgment process, the quality of said patterned medium is judged using said read data acquired in said inspection process.

5. The patterned medium inspection method according to claim 4, wherein, in said judgment process, the quality of said patterned medium is judged by comparing data written to said patterned medium in said inspection process and said read data.

6. The patterned medium inspection method according to claim 1, wherein, in said computation process, the signal interval values are determined on the basis of timing for which a strength of said reproduced signal read in said read process exceeds a predetermined threshold value.

7. The patterned medium inspection method according to claim 1, wherein, in said computation process, the signal interval values are determined on the basis of timing for which a strength of said reproduced signal read in said read process reaches a peak value.

8. The patterned medium inspection method according to claim 1, further comprising a magnetization process magnetizing magnetic dots on the surface of said patterned medium.

9. A patterned medium inspection apparatus comprising:
a magnetic head reading a reproduced signal of a patterned medium under inspection,
a signal interval value computation means computing signal interval values from the reproduced signal of said patterned medium read by said magnetic head, and
a judgment means judging a quality of said patterned medium using said signal interval values computed by said signal interval value computation means.

10. The patterned medium inspection apparatus according to claim 9, wherein, in said judgment means, the quality of said patterned medium is judged by comparing said signal interval values computed in said signal interval value computation means and a predetermined signal interval threshold value.

11. The patterned medium inspection apparatus according to claim 9, wherein, in said judgment means, the quality of said patterned medium is judged by comparing a strength of said reproduced signal read in said magnetic head and a predetermined signal strength threshold value.

12. The patterned medium inspection apparatus according to claim 9, further comprising:
a read/write means carrying out read/write processing from and to said patterned medium and acquiring read data from said patterned medium, and wherein:
in said judgment means, the quality of said patterned medium is judged using said read data acquired with said read/write means.

13. The patterned medium inspection apparatus according to claim 12, wherein, in said judgment means, the quality of said patterned medium is judged by comparing data written to said patterned medium by said read/write means and said read data.

14. The patterned medium inspection apparatus according to claim 9, wherein, in said signal interval value computation means, the signal interval values are determined on the basis of timing for which a strength of the reproduced signal read by said magnetic head exceeds a predetermined threshold value.

15. The patterned medium inspection apparatus according to claim 9, wherein, in said signal interval value computation means, the signal interval values are determined on the basis of timing for which a strength of the reproduced signal read by said magnetic head reaches a peak value.
